(19) United States
(12) Patent Application Publication
(10) Pub. No.: US 2018/0111879 A1
(43) Pub. Date: Apr. 26, 2018

(54) COMPOSITION FOR PREPARING A GREEN BODY FOR THE MANUFACTURE OF A REFRACTORY CARBON-BONDED PRODUCT, METHOD FOR PREPARING SUCH A GREEN BODY AND GREEN BODY PREPARED THEREBY

(71) Applicant: Refractory Intellectual Property GmbH & Co. KG, WIEN (AT)

(72) Inventors: Rainer Puchleitner, Graz (AT); Gisbert Riess, Leoben (AT); Wolfgang Kern, Seiersberg (AT); Günter Deutsch, Mautern (AT); Stefan Heid, Leoben (AT); Andreas Michelitsch, Kumberg (AT); Joachim Köhler, Leoben (AT)

(21) Appl. No.: 15/565,849

(22) PCT Filed: Mar. 15, 2016
(86) PCT No.: PCT/EP2016/055495

§ 371 Date: Oct. 11, 2017

(30) Foreign Application Priority Data
May 12, 2015 (EP) 15167428.0

(51) Int. Cl. C04B 35/05; C04B 35/634; C04B 35/626; C08G 59/66; C08F 122/20

(52) U.S. Cl. CPC C04B 35/05; C04B 35/63452; C04B 35/63424; C04B 35/6269; C04B 2235/48; C08F 122/20; C04B 2235/3206; C04B 2235/425; C08G 59/66

(57) ABSTRACT

The invention relates to a composition for preparing a green body for the manufacture of a refractory carbon-bonded product, a method for preparing such a green body and a green body prepared by such a method.

### DESCRIPTION

The invention relates to a composition for preparing a green body for the manufacture of a refractory carbon-bonded product, a method for preparing such a green body and a green body prepared by such a method.

For the purposes of the invention, the term “refractory product” denotes in particular refractory ceramic products with a working temperature above 600° C. and preferably refractory materials according to DIN 51060, that is to say materials with a pyrometric cone greater than SK17. The pyrometric cone may be determined in particular according to DIN EN 993-12.

A composition is generally known to refer to a compound of one or more components, with which a refractory product can be produced by means of thermal treatment, that is to say in particular by fire. Refractory products are in the form of refractory carbon-bonded products are also known. In refractory carbon-bonded products of such kind, a carbon bond predominates via which the refractory raw materials of the product are bound to each other.

Refractory carbon-bonded products are produced from compositions which comprise at least one refractory raw material and at least one carbon carrier as components. When such a composition is exposed to a thermal load, the carbon in the carbon carriers forms a carbon bond, via which the refractory raw materials are bonded to each other.

The essential components of a composition for producing a refractory carbon-bonded product are—besides at least one refractory raw material and the at least one carbon carrier—additionally at least one binder which lends the moulded, unfired composition sufficient strength. The composition may also comprise further components besides these, for example antioxidants in the form of metal powders of aluminium or silicon to prevent the carbon from being oxidised.

Moulded, unburned compositions that are bonded via a binder are also called green bodies. The carbon bond for creating the refractory carbon-bonded product from such a green body is typically not formed until said green body is used operationally at the temperatures which prevail under such conditions.

Particularly resin in the form of novolaks for example is also used as the binder in compositions for producing green bodies from which a refractory carbon-bonded product is then producible with the application of a thermal load. Since novolaks are solid at room temperature, novolaks may be used as binders in two different ways: firstly in the dissolved form, wherein organic solvents in particular are used, or in powder form as “powder resin”. It is also possible to melt the novolak at temperatures in the range from 70° C. to 100° C. and to work the composition infused with the molten novolak in a hot operation.

Handling such novolaks dissolved in organic solvents is not without difficulties, since many of the solvents used are harmful to health, for example. If novolak is used in the powder resin form, the use of such a powder resin alone usually does not enable the adequate green stability to be achieved. Finally, it is also particularly difficult to use novolak in hot operations, since the crosslinking resin is typically hard to handle not only in the green body but also in the aggregates used in the melting process.

The object underlying the invention is to provide a composition for manufacturing a green body for producing a refractory, carbon-bonded product, with which composition such a green body is particularly easily obtained. In particular, the composition should be constituted such that it includes a binder which lends the body good green stability. Moreover, the composition and the binder in the composition should be very easy to handle, and particularly in the aggregates used for processing the composition. In addition, the binder used for the composition should be as free as possible of substances that are harmful to health.

A further object of the invention consists in providing a method for obtaining a green body producible from such a composition.

A further object of the invention consists in providing a green body producible by such a method.

In order to solve the object, according to the invention a composition is provided for manufacturing a green body for producing a refractory carbon-bonded product that comprises the following components:

at least one refractory raw material;

at least one carbon carrier; and

at least one binder which comprises a resin and at least one initiator which initiates a curing reaction of the resin through ionising radiation.

Surprisingly, it was discovered according to the invention that the abovementioned objects can be solved using such a composition according to the invention. Insofar, it was found surprisingly that a green body for producing a refractory carbon-bonded product may be manufactured from a composition according to the invention, by irradiating the composition according to the invention with ionising radiation. For this purpose, the binder includes at least one initiator, which initiates a curing reaction of the resin when exposed to ionising radiation.

Therefore, the binder of the composition according to the invention, in particular for example a binder of the composition according to the invention based on epoxy resin or acrylate resin, does not have to be infused with organic solvents, which might contain substances that are harmful to health. Moreover, the composition according to the invention can be handled particularly easily. Thus, the polymerisation of the resin in the binder and consequently the curing of the composition to manufacture a green body can be initiated at a desired point in time quite easily by exposing the composition according to the invention to such ionising radiation, so that the initiator initiates a curing reaction in the resin.

It was found according to the invention that when the binder of the composition according to the invention cures due to the temperatures prevailing during the process, which are lower than for the binders used according to the prior art, significantly lower stresses were induced in the green body than in such green bodies as are produced according to the prior art. In this respect, it was found that the refractory carbon-bonded products produced from the green bodies that are manufactured from a composition according to the invention have better refractory properties than such green bodies as are produced according to the prior art. In particular, the strength of products produced on the basis of a composition according to the invention is typically better than the strength of green bodies produced according to the prior art.

It was further found according to the invention that curing of the binder by polymerisation of the resin—particularly an epoxy resin or acrylate resin—progresses significantly more quickly than the crosslinking in binders that are used for species-related compositions according to the prior art. This is very advantageous particularly from the point of view of process engineering.

In general, the composition according to the invention can be used to produce any refractory carbon-bonded product. To this extent, the composition according to the invention may comprise one or more refractory raw materials which are present in compositions for producing refractory carbon-bonded products according to the prior art. Accordingly, the composition may comprise for example one or more natural or synthetic raw materials which are used according to the prior art to produce refractory carbon-bonded products, in particular for example one or more raw materials based on one or more of the following oxides: MgO, Al₂O₃, SiO₂ or ZrO₂. Accordingly, the at least one refractory raw material may be formed from one or more of the following raw materials, for example: sintered magnesia, fused magnesia, sintered corundum, fused corundum, bauxite, spinel, calcined alumina, quartz or zircon.

The composition according to the invention may contain for example a proportion of refractory raw material for example in the range from 60 to 98 wt %, that is to say for example also a proportion of refractory raw material of at least 62, 64, 66, 68, 70, 72, 74, 76, 78 or 80 wt % and for example also a proportion of refractory raw material not exceeding 97, 96 or 95 wt %.

Unless otherwise indicated in individual cases, all wt % values cited herein relate to the mass of the respective component relative to the total weight of the composition according to the invention.

If the composition according to the invention is used to manufacture a green body for producing a refractory carbon-bonded product in the form of a magnesia-carbon product, the at least one refractory raw material may be produced for example from one of one or more of the following raw materials: fused magnesia or sintered magnesia.

If the composition according to the invention is used to manufacture a green body for producing a refractory carbon-bonded product in the form of an alumina-magnesia-carbon product, the at least one refractory raw material may be produced for example from one of one or more of the following raw materials: fused magnesia, sintered magnesia, fused corundum, sintered corundum, bauxite, spinel or calcined alumina.

The at least one carbon carrier may be one or more carbon carriers such as are used regularly in compositions for producing a refractory carbon-bonded product according to the prior art, that is to say for example at least one of the following raw materials: graphite or carbon black.

The composition according to the invention may include carbon carriers in a proportion for example in the range from 1 to 30 wt %, that is to say for example also in a proportion of at least 2, 3, 4 or 5 wt % and for example also in a proportion not exceeding 28, 26, 24, 22, 20, 19, 18, 17, 16 or 15 wt %.

According to the invention, the composition according to the invention comprises at least one binder which includes a resin, and at least one initiator, wherein the initiator is of such a kind as to initiate a curing reaction of the resin due to ionising radiation.

The resin of the binder may be radically curable resins, such as acrylate resins, or ionically curable resins, such as vinylether resins or epoxy resins.

If radically curable resins are provided, the initiator chosen is preferably one that generates radicals by ionising radiation, and thereby initiates the curing reaction of the resin. In this context, a chain reaction is set in motion by the released radicals in such manner as to polymerise and thus cure the resin.

If ionically curable resins are provided, the initiator chosen is preferably one that releases protons by ionising radiation, and thereby initiates the curing reaction of the resin. In this context, a chain reaction is set in motion by the released protons in such manner as to polymerise and thus cure the resin.

It may also be provided according to the invention that the binder comprises various resins or initiators, wherein at least one such resin and at least one such initiator are present with which a curing reaction of the resin is initiated by ionising radiation of the initiator.

The composition according to the invention may comprise a binder for example in a proportion in the range from 0.5 to 10 wt %, that is to say also for example in a proportion of at least 0.6 wt %, 0.7 wt %, 0.8 wt %, 0.9 or 1 wt % and for example also in a proportion not exceeding 9, 8, 7, 6 or 5 wt %.

The binder is preferably created exclusively from resins and initiators according to the invention.

The resin, comprised by the binder, includes terminal groups which are suitable for polymerisation, such as e.g., epoxy or vinylether terminal groups. If an epoxy resin is present as the resin, such resin contains cationically polymerisable epoxy groups. Thus, when a suitable initiator which releases H+ions or protons when exposed to ionising radiation is exposed to ionising radiation, a cationically polymerisable resin such as epoxy resin may be cured. This initiates the epoxy group, and subsequently a chain growth reaction (propagation) is started, during which the epoxy groups of the epoxy resin react with themselves, until this curing process is stopped by progressive vitrification. This cationic polymerisation or chain reaction, which in particular also continues without further influence or outer excitation, especially also without further ionising radiation, is also referred to in the prior art as “dark cure”.

In general, the binder resin in the form of an epoxy resin may be any epoxy resin or a resin that has been functionalised with epoxy groups, and which contains cationically polymerisable epoxy groups. Particularly preferably, the epoxy resin is an epoxy-novolak. In particular, an epoxy resin may be provided that has at least one of the following properties:
at least two epoxy groups;
aromatic rings;
low molecular weight.

The advantage of the at least two epoxy groups or the aromatic rings is that the resin cures quickly. The advantage of the low molecular weight is that the binder can be present in liquid form.

“Reactive diluents” which lower the viscosity of the epoxy resin and participate in the polymerisation or curing reaction during curing may also be added to the epoxy resin.

It is known from the prior art to combine a cationically polymerisable epoxy resin and a photoinitiator, and to initiate curing of the epoxy resin by exposing the photoinitiator to ionising radiation. Starting from this fundamental consideration, also in the binder of the composition according to the invention an epoxy resin is present beside such a photoinitiator, which releases protons under the effects of ionising radiation to initiate polymerisation of the epoxy resin under the influence of ionising radiation.

If the initiator provided is an initiator that releases protons under the effects of ionising radiation, the initiator is a cationic initiator that releases protons or H+ ions when exposed to ionising radiation. In this respect, the initiator is in particular a photoinitiator, particularly a cationic photoinitiator. The initiator of the binder in the composition according to the invention that releases protons upon exposure to ionising radiation is particularly preferably at least one onium salt, for example at least one of the following onium salts: oxonium salt, sulfonium salt, diaconium salt, phosphonium salt, arsonium salt, ammonium salt or a halonium salt such as for example bromonium salt or iodonium salt. In this context, such of these salts is chosen which release protons or H+ ions when irradiated with ionising radiation.

If an initiator in the form of an onium salt is present in the binder, the anion is generally freely selectable, wherein this anion may be chosen for example from the group consisting of hexafluoro antimonate (SbF6⁻), pentafluorophenyl borate (B[C₆F₅]₄⁻), hexafluoroarsenate (AsF₆⁻), hexafluorophosphate (PF₆⁻), tetrafluoroborate (BF₄⁻), trifluoromethane sulfonate (CF₃SO₃⁻) or [3,5-bis-(trifluoromethyl)phenyllborate (B[C₆H₃(CF₃)₄⁻ and mixtures thereof.

Particularly preferably, an onium salt chosen from the following group may be present as the initiator: diaryliodonium salt or triaryl sulfonium salt. Particularly preferably, these salts may comprise an anion in the form of hexafluoroantimonate.

Particularly if it is present in the form of the onium salts disclosed herein, the initiator be present in the binder in a proportion from 0.1 to 30 wt % relative to the total weight of the binder, that is to say for example also in a proportion of at least 0.5 wt %, 1 wt %, 2 wt %, 3 wt %, 4 wt % or 5 wt % and for example also in a proportion not exceeding 28, 26, 24 or 20 wt %. The remaining weight proportions in the binder are made up by the resin according to the invention, in particular an epoxy resin.

If the binder comprises a radically curable resin, the initiator provided is one which generates free radicals under the effects of ionising radiation and thus initiates the curing reaction of the resin. In this case, a radical chain polymerisation of the resin is set in motion by the generated radicals that is such as to polymerise and thereby cure the resin.

If “radically curable resins” are provided in the binder of the composition according to the invention, these are understood according to the invention to include the monomers or oligomers that can be caused to react by homopolymerisation or copolymerisation in such manner that they form the resin in question by radical chain polymerisation.

The binder may contain for example one or more of the following resins as the radically curable resins: acrylate resin, vinylester resin, alkyd resin, polyester resin, methacrylate resin and functionalised silicone resin. To this extent, the binder may contain the monomers or oligomers that can be crosslinked or cured to these resins. To this extent, the monomers or oligomers known from the prior art for this purpose may be used.

The radically curable resin is particularly preferably present in the form of an acrylate resin.

For example, the binder may comprise at least one of the monomers acrylic acid, methacrylic acid or esteres thereof to polymerise acrylate resin. The binder may further comprise for example at least one of the following monomers: styrene, butadiene or acrylonitrile. The binder may also comprise multifunctional compounds, for example hexanediol diacrylate, pentaerythrol-tetraacrylate, pentaerythrol-triacrylate or trimethylolpropane-triacrylate. Such multifunctional compounds may themselves constitute the binder, or they may be added to an acrylate resin for example as a reactive diluent.

If an initiator is provided that releases free radicals under the effects of ionising radiation, the initiator is a radical initiator or a radical starter. In this case, the initiator is particularly a radical photoinitiator. The radical initiator of the binder of the composition according to the invention which generates free radicals under the effects of ionising radiation may be selected for example from the following group: aromatic-aliphatic ketones, full-aromatic ketones, substituted phosphine oxides, peroxo compounds and diazo compounds.

The radical initiator of the binder of the composition according to the invention may particularly preferably be chosen from the following group: 2-Hydroxy-2-methyl-1-phenylpropanone, 2-Methyl-1-[4-(methylthio)phenyl]-2-morpholinopropan-1-one, benzophenone, ethyl (2,4,6-trimethylbenzoyl) phenylphosphinate, 2,4,6-trimethylbenzoyl-diphenylphosphine oxide, dibenzoyl peroxide and azo-bis-(isobutyronitrile).

In the binder, the radical initiator for example may be present in a proportion from 0.1 to 30 wt % relative to the total weight of the binders, also for example in a proportion of at least 0.5 wt %, 1 wt %, 2 wt %, 3 wt %, 4 wt % or 5 wt % and for example also in a proportion not exceeding 28, 26, 24 or 20 wt %. The remaining weight proportions of the binder are made up by the resin according to the invention, for example an acrylate resin.

As further components, the composition according to the invention may comprise one or more antioxidants, particularly antioxidants which may contain compositions for producing refractory carbon-bonded products according to the prior art, i.e. for example one or more of the following antioxidants: aluminium powder, silicon powder, powder from aluminium-magnesium alloys, carbides or borides.

The composition according to the invention comprises corresponding antioxidants for example in a proportion of less than 2 wt %, also for example in a proportion of less than 1 wt %. The composition may comprises antioxidants in a proportion of at least 0.1 wt %, also in a proportion of at least 0.5 wt % for example.

It has been found according to the invention that, particularly if the resin is present in the form an epoxy resin or acrylate resin, the polymerisation chain reaction of the resin may react very sensitive to further components, so that the polymerisation of the resin may be suppressed by further components present in the composition according to the invention besides those components provided according to the invention. To this extent, it may thus be provided according to the invention that beside the components disclosed herein, that is to say beside at least one refractory raw material, at least one carbon carrier, at least one binder and at least one antioxidant the composition according to the invention may comprise further components in a proportion of less than 10 wt %, in particular in a proportion of less than 9, 8, 7, 6, 5, 4, 3, 2 or 1 wt %.

In particular, it has been found that the composition reacts very sensitive to the presence of thermoplastics, elastomers and plasticisers which are present in the composition besides the resin. To this extent, it may be provided that the total weight of thermoplastics, elastomers and plasticisers present in the composition is less than 3 wt %, particularly less than 2, 1 or 0.5 wt %.

A further object of the invention is a method for preparing a green body for the manufacture of a refractory carbon-bonded product, comprising the following steps:

Providing the composition according to the invention described herein,

Exposing the composition to such an ionizing radiation that the initiator initiates a curing reaction of the resin, that is to say in particular that the initiator releases protons or radicals, by which the resin is cured cationically or radically.

The composition is particularly preferably exposed to ionising radiation in the form of x-ray radiation or gamma radiation. Surprisingly, it was found according to the invention that the initiation of the polymerisation of the resin, particularly an epoxy resin or acrylate resin can be induced particularly simply and reliably by exposing the composition to x-ray radiation or gamma radiation. Such x-ray radiation or gamma radiation for initiating the polymerisation of the resin also has the advantage in particular that nowadays x-ray radiation is relatively easy to manage and is therefore readily usable on even on an industrial scale to cure the composition according to the invention. In this context, it was found according to the invention that a polymerisation of the resin can be carried out quickly and easily by x-ray radiation or gamma radiation.

The composition may be exposed to x-ray radiation or gamma radiation in a closed radiation chamber, for example, so that the environment is not exposed to x-ray radiation or gamma radiation.

It was found according to the invention that in order to cure the binder the composition must be exposed to a radiation dose particularly in the range from 1 to 100 kGy, and particularly preferably in the range from 7 to 40 kGy, thus for example also a radiation dose of at least 15 kGy and for example also a radiation dose not exceeding 22 kGy. When the composition is irradiated with such a radiation dose, the polymerisation of the cationically or radically polymerisable resins is reliably started, and a substantially complete curing of the resin is assured.

The composition is preferably exposed to a radiation power in the range from 1 to 7 kGy per minute. In general, the dosage rate can be chosen at will, but may preferably be at least 0.1 kGy/min.

In this context, the composition is exposed to x-ray radiation at such radiation power that the radiation is delivered to the composition at the preferred dose described previously, for example a period in the range from 20 s to 60 min, preferably for a period in the range from 2 to 30 min or 3 to 20 min.

According to one embodiment, it may be provided that the step of polymerisation by exposing the composition to ionising radiation is followed by a postprocessing step. In this context, it may be provided for example that the composition is subjected to heat treatment after complete polymerisation of the resin. Because it was found according to the invention the such a thermal load applied to a composition after the polymerisation or curing step makes it possible to increase the strength of the green body. In this case, it may be provided for example that after its exposure to ionising radiation the composition is exposed to a temperature in the range from 50 to 200° C. that is to say for example a temperature of at least 60, 70 or 80° C. and for example a temperature not exceeding 180, 160, 140, 120 or 110° C. For example, the composition may be exposed to a temperature of about 90° C.

The composition may be exposed to such a temperature in a kiln for example.

A further object of the invention is a green body for preparing a refractory carbon-bonded product which is produced by the method according to the invention.

In this context, a green body according to the prior art is understood to be the composition according to the invention which has been strengthened by the cured binder but which does not yet have a carbon bond. To create such a carbon bond, the green body is subjected to a subsequent thermal treatment, particularly with regard to the intended use of the green body or of the refractory carbon-bonded product prepared therefrom.

Embodiments of the invention will be explained in greater detail with reference to the following examples.

All features of the invention may be combined with each other individually or in any combination.

### EXAMPLE 1

The composition according to the invention according to embodiment 1 contains the components in the mass percentages shown in table 1 below.

TABLE 1

| Component | Proportion [wt %] |
|---|---|
| Fused magnesia | 88.5 |
| Graphite | 8.5 |
| Binder | 3.0 |

According to embodiment 1, a refractory raw material was provided in the form of fused magnesia. The grain size of the fused magnesia was in a range between larger 0 and 5 mm. The fused magnesia contained a proportion of 98 wt % MgO and 2% by-phases, particularly in the form of CaO, SiO₂, Al₂O₃ and Fe₂O₃.

The carbon carrier of the composition according to embodiment 1 was present in the form of graphite with a proportion of carbon of 94 wt %.

The binder included a proportion of resin in the form of epoxy-novolak of 85 wt % and a proportion of an initiator in the form of triaryl sulfonium-hexafluoroantimony salt of 15 wt %, relative in each case to the total weight of the binder.

The corrspondingly prepared composition was mixed at a temperature of 50° C. for 10 minutes. Then the mixed composition was allowed to rest.

The composition was then moulded by pressing to form a moulded body, and this moulded body was then exposed to x-ray radiation with a radiation dose of 3.6 kGy. The x-ray radiation caused the triarylsulfonium-hexafluoroantimony salt to release protons, which initiated a chain reaction of the epoxy-novolak, wherein the epoxy groups of the epoxy-novolak polymerised with each other until the epoxy-novolak was completely cured.

Then, a green body was obtained with which a refractory carbon-bonded product could be prepared.

This green body was subjected to a temperature of 90° C. as part of a postreatment step, thereby improving the strength properties of the green body.

### EXAMPLE 2

The composition corresponds to that of embodiment 1, the only difference being that the binder contained a proportion of resin in the form of acrylate resin, specifically pentaerythritol triacrylate (CAS number 3524-68-3) of 85 wt % and a proportion of an initiator in the form of ethyl-(2,4,6-trimethylbenzoyl)phenylphosphinate of 15 wt %, relative in each case to the total weight of the binder.

The correspondingly prepared composition was mixed at a temperature of 50° C. for 10 minutes. Then the mixed composition was allowed to rest.

The composition was then moulded by pressing to form a moulded body, and this moulded body was then exposed to x-ray radiation with a radiation dose of 3.6 kGy. The x-ray radiation caused the ethyl-(2,4,6-trimethylbenzoyl)phenylphosphinate to generate radicals, which initiated a chain reaction in the acrylate resin, so that it polymerised and completely cured.

This yielded a green body for preparing a refractory carbon-bonded product.

This green body was exposed to a temperature of 90° C. in a post-treatment step, thereby improving the strength properties of the green body.

1. A composition for preparing a green body for the manufacture of a refractory carbon-bonded product, comprising the following components:
at least one refractory raw material,
at least one carbon carrier, and
at least one binder which comprises:
a resin, and
at least one initiator which initiates a curing reaction of the resin through ionizing radiation.

2. The composition according to claim 1 having a proportion of refractory base material in the range of 60 to 98% by mass.

3. The composition according to claim 1 in which the percentage of binder is in the range from 0.5 to 10% by mass.

4. The composition according to claim 1 having a binder consisting of an ionically curable resin and a cationic photoinitiator.

5. The composition according to claim 1 having an ionically curable resin in the form of an epoxy resin.

6. The composition according to claim 1 having a cationic photoinitiator in the form of an onium salt.

7. The composition according to claim 1 with a binder consisting of a radically curable resin and a free radical photoinitiator.

8. The composition according to claim 1 with a radically curable resin in the form of acrylate resin.

9. The composition according to claim 1 having a free radical photoinitiator selected from the group: benzophenone, aromatic phosphine oxides, phosphonates, peroxides or azo-compounds.

10. A method for preparing a green body for the manufacture of a refractory carbon-bonded product, comprising the following steps:
providing a composition, the composition comprising the following components:
at least one refractory raw material,
at least one carbon carrier, and
at least one binder which comprises
a resin, and
at least one initiator which initiates a curing reaction of the resin through ionizing radiation,
exposing the composition to such an ionizing radiation that the initiator initiates a curing reaction of the resin.

11. The method according to claim 10, wherein the composition is exposed to X-rays or gamma radiation.

12. The method according to claim 11, wherein the composition is exposed to a radiation dose in the range from 1 to 100 kGy.

13. A green body for preparing a refractory carbon-bonded product which is produced by a method, the method comprising:
providing a composition, the composition comprising the following components:
at least one refractory raw material,
at least one carbon carrier, and
at least one binder which comprises
a resin, and
at least one initiator which initiates a curing reaction of the resin through ionizing radiation,
exposing the composition to such an ionizing radiation that the initiator initiates a curing reaction of the resin.
